(19) United States
(12) Patent Application Publication
(10) Pub. No.: US 2016/0289526 A1
(43) Pub. Date: Oct. 6, 2016

(54) TREATMENT OF SUBTERRANEAN FORMATIONS WITH COMPOSITIONS INCLUDING POLYETHER-FUNCTIONALIZED POLYSILOXANES

(71) Applicant: HALLIBURTON ENERGY SERVICES, INC., Houston, TX (US)

(72) Inventors: Ali Alwattari, Kingwood, TX (US); Janette Cortez, Kingwood, TX (US); Bradley J. Sparks, Richmond, TX (US)

(73) Assignee: Halliburton Energy Services, Inc., Houston, TX (US)

(21) Appl. No.: 15/035,296

(22) PCT Filed: Feb. 11, 2014
(86) PCT No.: PCT/US2014/015826

§ 371 Date: May 9, 2016

(51) Int. Cl. C09K 8/035; C09K 8/52; C09K 8/72; C09K 8/68; C09K 8/88; C09K 8/467; C09K 8/54

(52) U.S. Cl. CPC C09K 8/035; C09K 8/467; C09K 8/52; C09K 8/54; C09K 8/68; C09K 8/885; C09K 8/685; C09K 8/725; C09K 2208/32; C09K 2208/28; C09K 2208/24; C09K 2208/26

(57) ABSTRACT

Various embodiments disclosed relate to compositions including polyether-functionalized linear polysiloxanes and methods and systems for using the same to treat subterranean formations. In various embodiments, the present invention provides a method of treating a subterranean formation including obtaining or providing a composition including a polyetherfunctionalized linear polysiloxane. The method also includes placing the composition in a subterranean formation.

### BACKGROUND OF THE INVENTION

Surfactants are useful in subterranean formations for a variety of oil-recovery operations. However, existing downhole surfactants and methods of using the same suffer from various inadequacies such as high cost and inefficiency or ineffectiveness in treating large subterranean surfaces such as fractures or proppant located therein or in treating large volumes of liquid.

### SUMMARY OF THE INVENTION

In various embodiments, the present invention provides a method of treating a subterranean formation. The method includes obtaining or providing a composition including a polyether-functionalized linear polysiloxane. The method also includes placing the composition in a subterranean formation.

In various embodiments, the present invention provides a method of treating a subterranean formation. The method includes obtaining or providing a composition including a polyether-functionalized linear polysiloxane having the structure

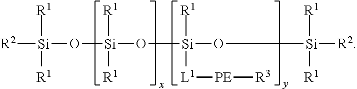

At each occurrence, R¹ is independently selected from a (C₁-C₅)alkyl. At each occurrence, R² is independently selected from the group consisting of —R¹ and -L¹-PE-R³. At each occurrence, L¹ is independently selected from the group consisting of a bond and a (C₁-C₅)alkylene. At each occurrence, PE is independently selected from —(O—R⁴)ₙ—O—. At each occurrence, R⁴ is independently a substituted or unsubstituted (C₂-C₅)alkylene. At each occurrence, R³ is independently selected from the group consisting of —H, methyl, and ethyl. The variable n is about 1 to about 10,000, x is about 0 to about 100,000, y is about 0 to about 100,000, and x+y is at least 1. The polyether-functionalized polysiloxane includes at least one polyether. The composition also includes at least one of a fracturing fluid or a drilling fluid. About 0.000,1 wt % to about 10 wt % of the composition is the polyether-functionalized polysiloxane. The method also includes placing the composition in a subterranean formation.

In various embodiments, the present invention provides a system. The system includes a composition including a polyether-functionalized linear polysiloxane. The system also includes a subterranean formation including the composition therein.

In various embodiments, the present invention provides a composition for treatment of a subterranean formation. The composition includes a polyether-functionalized linear polysiloxane. The composition also includes a downhole fluid.

In various embodiments, the present invention provides a composition for treatment of a subterranean formation. The composition includes a polyether-functionalized linear polysiloxane having the structure

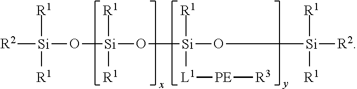

At each occurrence, R¹ is independently selected from a (C₁-C₅)alkyl. At each occurrence, R² is independently selected from the group consisting of —R¹ and —C—PE-R³. At each occurrence, L¹ is independently selected from the group consisting of a bond and a (C₁-C₅)alkylene. At each occurrence, PE is independently selected from —(O—R⁴)ₙ—O—. At each occurrence, R⁴ is independently a substituted or unsubstituted (C₂-C₅)alkylene. At each occurrence, R³ is independently selected from the group consisting of —H, methyl, and ethyl. The variable n is about 1 to about 10,000, x is about 0 to about 100,000, y is about 0 to about 100,000, and x+y is at least 1. The polyether-functionalized polysiloxane includes at least one polyether. The composition also includes at least one of a fracturing fluid or a drilling fluid. About 0.000,1 wt % to about 10 wt % of the composition is the polyether-functionalized polysiloxane.

In various embodiments, the present invention provides a method of preparing a composition for treatment of a subterranean formation. The method includes forming a composition including a composition including a polyether-functionalized linear polysiloxane. The composition also includes a downhole fluid.

Various embodiments of the present invention provide certain advantages over other compositions, methods, and systems for treatment of a subterranean formation, at least some of which are unexpected. For example, in some embodiments, compared to other surfactants, the polyether-functionalized polysiloxanes can provide surfactant properties using a different mechanism that can more effectively enhance production, such as by providing greater wetting, providing decreased surface tension between fluids, providing a more sustained effect throughout various operations, provide greater effect over a larger area using a lower quantity of surfactant or at a lower cost, or by more effectively increasing the fracturing fluid performance. In some embodiments, the increased wetting can provide more effective fracturing, and can provide improved regain permeability. In some embodiments, the decreased surface tension between water and oil can provide recovered oil having less water therein, or recovered water having less oil therein.

In some embodiments, the chemical structure of polyether-functionalized polysiloxane can be adjusted to tailor surfactant properties for desired use, such as types of fluid interface (e.g., between fluids, or between a fluid and a solid), and type of property and application desired, allowing for a wide variety of possible applications. For example, the composition including the polyether-functionalized polysiloxane can be used for a wide variety of applications relating to interface modification between a fluid including the functionalized polysiloxane and another fluid or a solid, such as antifoaming, de-aeration, improved wetting, mar-resistance, regain permeability enhancement, lubrication, corrosion inhibition, improved leveling, faster water drop, the production of higher quality oil or water due to a cleaner interface between the liquids, and improved low temperature processing efficiency.

In various embodiments, the polyether-functionalized polysiloxane can have special properties in the subterranean formation at least in part resulting from the effect of hydrophilic polyalkylene oxide components and the effect of hydrophobic siloxane portions of the polymer. In some embodiments, the combined hydrophobic and hydrophilic moieties of the polyether-functionalized polysiloxane can provide an extensive and rapid wetting behavior of the molecule at an aqueous interface with another liquid or with a solid referred to as “superspreading.” In some embodiments, at an aqueous interface, the polyether-functionalized polysiloxane can provide a bilayer aggregate microstructure (e.g. vesicles, lamellar phases) rather than conventional micelles, leading to a higher concentration of surfactant at the greater area of interface than provided by other surfactants. In some embodiments, the combination of lamellar microstructure, low surface tension, and interface accumulation by the polyether-functionalized polysiloxane can result in a substantial increase in spreading velocity as compared to other surfactants, which corresponds to a faster and broader spread of surfactant in a fracture or other subterranean space.

In various embodiments, the high chain flexibility of the polysiloxane functionalities of the polyether-functionalized polysiloxane can provide facile conformation changes, allowing the polysiloxane to closely interact with a wide variety of surface geometries. In various embodiments, the polyether-functionalized polysiloxane can provide multifunctional surfactant benefits in aqueous systems at very low concentrations (e.g, 0.000,1 wt % to about 5 wt %) and can be stable up to about 320° F. about 400° F. or about 320° F. to about 360° F.

In various embodiments, the polyether-functionalized polysiloxane can be used in a concentrated solution (e.g., as a slug or in a concentrated dose downhole), or in a composition in more dilute form. In various embodiments, by using the polyether-functionalized polysiloxane in aqueous or nonaqueous form before, during, or after a particular operation (e.g., even if not placed into the same composition as used during the operation), a subterranean formation can be modified advantageously, such as to intensify penetration speed and depth of various compounds and components, such as polymers and proppants, or can increase or maximize fluid-to-rock force and pressure transmission that can cause fractures. In various embodiments, the polyether-functionalized polysiloxane can be used to pre-treat, or to treat during a downhole operation, various equipment downhole such as tubulars, drill bits, wireline components, perforating guns, pumps, and other equipment, to allow for reduced friction, reduced build-up of undesired materials, or reduced corrosion.

In various embodiments, the polyether-functionalized polysiloxane can provide diversion or fluid loss control, such as of aqueous materials or oils and organic materials. In various embodiments, the polyether-functionalized polysiloxane can be used as a friction reducer. In various embodiments, the polyether-functionalized polysiloxane can be used to coat proppants, which can allow more uniform placement and packing of the proppant in a fracture. In various embodiments, the polyether-functionalized polysiloxane can be used in a blocked or masked form allowing for triggered delivery at a desired location.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R′)₂, CN, NO, NO₂, ONO₂, azido, CF₃, OCF₃, R′, O (oxo), S (thiono), C(O), S(O), methylenedioxy, ethylenedioxy, N(R), SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing 3 or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

### Method of Treating a Subterranean Formation.

In various embodiments, the present invention provides compositions including polyether-functional polysiloxanes for use subterranean use and methods of using the same. Various embodiments of the polyether-functional polysiloxane can modify properties at various fluid or solid interfaces, such as between multiple fluids or between a fluid and a solid, such as oil/water, pad or pre-pad fluid/rock, fracturing fluid fluid/rock, fracturing fluid/proppant, post-fracturing fluid/rock or proppant, oil/rock, water/rock, proppant/fracture, and oil/piping. The polyether-functionalized siloxane can perform various functions depending on during which operation the polysiloxane is introduced to the subterranean formation. For example, during a fracturing operation, various functions can be performed by the polyether-functionalized polysiloxane when introduced in a pad fluid, simultaneously with the fracturing fluid, or in post-fracturing fluids such as a flush.

In some embodiments, the present invention provides a method of treating a subterranean formation. The method includes obtaining or providing a composition including a polyether-functionalized polysiloxane. The obtaining or providing of the composition can occur at any suitable time and at any suitable location. The obtaining or providing of the composition can occur above the surface. The obtaining or providing of the composition can occur in the subterranean formation (e.g., downhole). The method also includes placing the composition in a subterranean formation (e.g., downhole). The placing of the composition in the subterranean formation can include contacting the composition and any suitable part of the subterranean formation, or contacting the composition and a subterranean material downhole, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include contacting the polyether-functionalized polysiloxane with portions of the subterranean formation. The placing of the composition in the subterranean formation can include at least partially depositing the composition in a fracture, flow pathway, or area surrounding the same.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

In some embodiments, in addition to the polyether-functionalized polysiloxane, the composition can include an aqueous liquid. The method can further include mixing the aqueous liquid with the functionalized polysiloxane. The mixing can occur at any suitable time and at any suitable location, such as above surface or in the subterranean formation (e.g., downhole). The aqueous liquid can be any suitable aqueous liquid, such as at least one of water, brine, produced water, flowback water, brackish water, and sea water. In some embodiments, the aqueous liquid can include at least one of a drilling fluid (e.g., aqueous drilling fluid) and a fracturing fluid (e.g., aqueous fracturing fluid, such as at least one of a pre-pad fluid, a pad fluid, a fracturing fluid, and a post-fracturing fluid).

The composition can include any suitable proportion of the aqueous liquid, such that the composition can be used as described herein. For example, about 0.000,000,01 wt % to 99.999,99 wt % of the composition can be the aqueous liquid, or about 0.000,1 wt % to about 99.9 wt %, about 0.1 wt % to about 99.9 wt %, or about 20 wt % to about 90 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999,9, or about 99.999,99 wt % or more of the composition can be the aqueous liquid.

The aqueous liquid be a salt water. The salt can be any suitable salt, such as at least one of NaBr, CaCl₂, CaBr₂, ZnBr₂, KCl, and NaCl. The polyether-functionalized polysiloxane can effectively provide surfactant properties in aqueous solutions having various total dissolved solids levels, or having various ppm salt concentrations. The polyether-functionalized polysiloxane can provide surfactant properties in a salt water having any suitable total dissolved solids level (e.g., wherein the dissolved solids correspond to dissolved salts), such as about 1,000 mg/L to about 250,000 mg/L, or about 1,000 mg/L or less, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The polyether-functionalized polysiloxane can provide surfactant properties in salt water having any suitable salt concentration, such as about 1,000 ppm to about 300,000 ppm, or about 1,000 ppm to about 150,000 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the aqueous liquid can have a concentration of at least one of NaBr, CaCl₂, CaBr₂, ZnBr₂, KCl, and NaCl of about 0.1% w/v to about 20% w/v, or about 0.1% w/v or less, or about 0.5% w/v, 1, 2, 3, 4, 5, 6, 7, 8, 9, 10, 11, 12, 13, 14, 15, 16, 17, 18, 19, or about 20% w/v or more.

The polyether-functional polysiloxanes can be used for a wide variety of applications relating to interface modification between a fluid including the functionalized polysiloxane and another fluid or a solid, such as antifoaming (e.g., for drilling fluids, optionally in conjunction with diverters), de-aeration (e.g., deoxygenation of water for well injection, de-aeration of casing cement, de-aerataion of drilling fluids), improved wetting (e.g., to rock, proppant, fractures, plastic), mar-resistance, regain permeability enhancement, lubrication (e.g., drag reduction), corrosion inhibition (e.g., due to blocking scale formation at surfaces), improved leveling, faster water drop (e.g., faster breaking of emulsions and lower emulsion stability), higher quality produced oil or produced water due to a cleaner interface between the liquids, and improved low temperature processing efficiency.

The polyether-functionalized polysiloxane can be added to a variety of downhole fluids, such as fracturing fluids (e.g., pre-pad fluid, pad fluid, fracturing slurry, or post-fracturing fluids), cements, drilling fluids, and other suitable downhole fluids. In some embodiments, the polyether-functionalized polysiloxane can be used neat or in high concentration with little to no other fluids present, for example, as a pre-treatment before fracturing, during a fracture treatment, or as a finishing step post-fracturing to improve recovery or clean up materials remaining after fracturing such as proppant carrier components.

In some embodiments, the polyether-functionalized polysiloxane can be used as a friction reducer, either as a part of a composition to be applied to the subterranean formation for another purpose, or as a pre-treatment (e.g., to reduce friction in tubulars and other equipment).

In some embodiments, the polyether-functionalized polysiloxane can be used to provide diversion or water control, such as of aqueous materials or oils and organic materials. For example, by treating a subterranean flowpath with the polyether-functionalized polysiloxane, water, oil, or a combination thereof can be at least partially repelled from the flowpath, depending on the characteristics of the surface of the flowpath (e.g., polar or non-polar) and depending on the molecular weight and other structural characteristics of the polyether-functionalized polysiloxane.

Various polyether-functionalized polysiloxanes can be solid, semi-solid, or liquid above-surface, depending on the chemical structure and the above-surface temperature. Likewise, various polyether-functionalized polysiloxanes can be solid, semi-solid, or liquid in the subterranean formation, such as at a location where the compound is desired to be applied, depending on the conditions in the subterranean formation such as temperature and pressure. In some embodiments, the polyether-functionalized polysiloxane forms a homogeneous mixture with the composition. In some embodiments, the polyether-functinalized polysiloxane forms a heterogenous mixture with the composition, such as in the form of solid or semi-solid particulates of any suitable size in the composition.

In various embodiments, the composition can include a proppant coated with the polyether-functionalized polysiloxane. In some examples, the coating on the proppant can improve slip and can allow more uniform placement and packing of the proppant in a fracture. The polyether-functionalized polysiloxane can be coated on the proppant in a wet coat process (e.g., addition of the polyether-functionalized polysiloxane while the proppant is in a liquid composition such as a fracturing fluid) or in a dry coat process (e.g., addition of additive to dry proppant). The coated proppant can be pre-made or can be made on demand at a worksite.

In some embodiments, the polyether-functionalized polysiloxane can be blocked or masked to allow for a triggered-release of the material at a desired location. For example, any suitable encapsulation or microencapsulation technology can be used to encapsulate the polyether-functionalized polysiloxane for a later triggered-release. In some embodiments, various materials can be used to at least partially coat a solid or semi-solid polyether-functionalized polysiloxane for later triggered-release, such as waxes (e.g., paraffin wax), any suitable material having a melting point between about 35° F. and about 500° F., a starch, a resin, a gel, or a combination thereof. Examples of resins include a natural resin, a polyisocyanate resin, a urethane resin, a polyester resin, an epoxy resin, a novolac resin, a polyepoxide resin, bisphenol A-epichlorohydrin resin, a bisphenol A diglycidyl ether resin, a butoxymethyl butyl glycidyl ether resin, a bisphenol F resin, a glycidyl ether resin, a phenol-aldehyde resin, a phenolic-latex resin, a phenol-formaldehyde resin, a urea-aldehyde resin, a urethane resin, a polyurethane resin, a phenolic resin, a furan resin, a furan-furfuryl alcohol resin, and an acrylate resin. Other examples of resins include a shellac, a polyamide, a silyl-modified polyamide, a polyester, a polycarbonate, a polycarbamate, an acrylic acid polymer, an acrylic acid ester polymer, an acrylic acid homopolymer, an acrylic acid ester homopolymer, poly(methyl acrylate), poly(butyl acrylate), poly(2-ethylhexyl acrylate), an acrylic acid ester copolymer, a methacrylic acid derivative polymer, a methacrylic acid homopolymer, a methacrylic acid ester homopolymer, poly(methyl methacrylate), poly(butyl methacrylate), poly(2-ethylhexyl methacrylate), an acrylamidomethylpropane sulfonate polymer or copolymer or derivative thereof, an acrylic acid/acrylamidomethylpropane sulfonate copolymer, a trimer acid, a fatty acid, a fatty acid-derivative, maleic anhydride, acrylic acid, a polyester, a polycarbonate, a polycarbamate, an aldehyde, formaldehyde, a dialdehyde, glutaraldehyde, a hemiacetal, an aldehyde-releasing compound, a diacid halide, a dihalide, a dichloride, a dibromide, a polyacid anhydride, citric acid, an epoxide, furfuraldehyde, an aldehyde condensate, a silyl-modified polyamide, a condensation reaction product of a polyacid and a polyamine, and a hydrophobically-modified amine-containing polymer. Examples of gels can include polysaccharide gel, gels formed from polyvinyl alcohol, vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, a substituted or unsubstituted (C₁-C₂₀)alkyl ester thereof, or a copolymer thereof. In some embodiments, a breaker can be used to help break a gel in a subterranean formation to release the polyether-functionalized polysiloxane. In some embodiments, an emulsion can be used to stabilize the polyether-functionalized polysiloxane, wherein conditions in the subterranean formation or added emulsion-breaking materials cause the emulsion to break at a location of triggered-release.

The polyether-functionalized polysiloxane can be used in a concentrated solution, e.g., as a slug or in a concentrated dose in a subterranean formation (e.g., downhole), or in a composition in more dilute form. In various embodiments, the polyether-functionalized polysiloxane can be used in a pre-flush to coat the inner lining of piping and pumps to reduce power consumption and friction and wear. In some embodiments, the polyether-functionalized polysiloxane can be used to dip-coat various equipment such as drill bits and teeth for easier assembly and performance during grinding, wireline components for well logging, and perforating guns. The polyether-functionalized polysiloxane can be applied to joints and connections along the pumping path to smooth out nonuniformities or flow discontinuities, e.g., elbows, sharp turns in pipelines. In various embodiments, the polyether-functionalized polysiloxane can prevent or reduce buildup of residue or soiling on surfaces such as filters, sharp edges of rock or other equipment that benefits from staying clean, such as sensors or detectors. In some embodiments, treating a tubular with a composition including the polyether-functionalized polysiloxane can reduce friction therein, and can reduce embedment of proppant or other particulate materials in a composition placed therein.

In one embodiment, the polyether-functionalized polysiloxane can be included in a pad fluid, where it can migrate to the formation surface, modifying its physical and chemical properties. This treatment prior to pumping fracturing fluid can result in enhanced wetting characteristics of the formation and reduced friction in the following stages of the job, for example, when proppant-laden fluid is introduced.

In another embodiment, the polyether-functionalized siloxane can be incorporated into the formulation of a fracturing fluid. In this example, the polysiloxane can decrease friction, increase spreadability or degree of contact of the composition with the formation microstructure (e.g., granule geometry of rock and proppant), and increase the wettability of the composition onto rock (defoaming, coating pores).

In another embodiment, the polyether-functionalized siloxane can be added to a post-fracturing flush (e.g., a fluid flush to clear out the wellbore after pumping fracturing fluid). The polyether-functionalized siloxane can treat the surface of the formation or the proppant in the subterranean formation to improve permeability of the formation and improve the production of the well.

In one example, the composition has a composition of about 0.004 wt % to about 0.01 wt % viscosifier, about 96 wt % water (e.g., base fluid), about 0.01 wt % to about 5 wt % polyether-functionalized polysiloxane, about 0.001 wt % to about 0.01 wt % optional crosslinker, and about 0.01 wt % to about 0.1 wt % optional breaker.

### Polyether-Functionalized Linear Polysiloxane.

The composition includes a polyether-functionalized linear polysiloxane. In various embodiments, the polyether-functionalized polysiloxane can be highly surface active due to low surface tension caused by the large number of alkyl groups and due to the small intermolecular attractions between the siloxane hydrophobes. The siloxane backbone of the molecule can be highly flexible, which can allow for maximum orientation of the attached groups at interfaces. The polyether-functionalized polysiloxane can be non-ionic, having both a hydrophilic part (e.g., low molecular-weight polymer of ethylene oxide or propylene oxide or both) and a hydrophobic part (e.g., a methylated polysiloxane moiety). In some embodiments, polyether groups such as ethylene oxide or propylene oxide can be attached to a side chain of the polysiloxane backbone through a hydrosilylation or condensation process.

There is a great degree of flexibility in designing the polyether-functionalized polysiloxanes, with variations such as molecular weight, molecular structure (terminal or intermediate substitution of the polyether), the composition of the polyether chain (e.g., ethylene oxide or propylene oxide), and the ratio of polysiloxane to polyether. The molecular weight can influence the rate of migration to the interface. Increased molecular weight of the polyether-functionalized polysiloxane can lead to an increased viscosity, but can also give greater substantivity to surfaces and improved shine level. Other variables can include absence or presence of functionality or end groups on the polyether fragments (e.g., —H or alkyl). Depending on the ratio of various polyethers, such as ethylene oxide to propylene oxide, the functionalized polysiloxane molecules can be water soluble, dispersible or insoluble in water. In some embodiments, a more soluble polyether-functionalized polysiloxane can be designed to have good solubility in a solution to give efficient wetting of the same. In some embodiments, a less soluble polyether-functionalized polysiloxane can provide other useful properties, such as antifoaming properties. Variation of the structure can affect how the molecules can pack at an interface. With ether groups substituted at intermediate polysiloxane units, in aqueous media, the silicone backbone can align itself with the interface, leaving the polyalkylene oxide groups projecting into the water.

Any suitable proportion of the composition can be the polyether-functionalized polysiloxane, such that the composition or a mixture including the same can be used as described herein. For example, about 0.000,1 wt % to about 100 wt % of the composition can be the polyether-functionalized linear polysiloxane, about 0.01 wt % to about 5 wt %, or about 0.000,1 wt % or less, or about 0.001 wt %, 0.01, 0.1, 1, 2, 3, 4, 5, 10, 15, 20, 25, 30, 35, 40, 45, 50, 55, 60, 65, 70, 75, 80, 85, 90, 95, 96, 97, 98, 99, 99.9, 99.99, 99.999, 99.999,9 wt % or more.

In some embodiments, the polyether-functionalized polysiloxane has the structure:

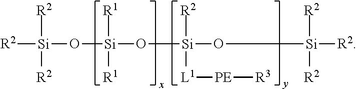

The sum x+y is at least 1. The polyether-functionalized polysiloxane includes at least one polyether.

At each occurrence, R¹ can be independently selected from a substituted or unsubstituted (C₁-C₂₀)hydrocarbyl. At each occurrence, R¹ can be independently selected from (C₁-C₂₀)alkyl. At each occurrence, R¹ can be independently selected from (C₁-C₅)alkyl. At each occurrence, R¹ can be methyl.

At each occurrence, R² can be independently selected from the group consisting of —R¹ and -L¹-PE-R³. At each occurrence, L¹ can be independently selected from the group consisting of a bond and a substituted or unsubstituted (C₁-C₂₀)alkylene. At each occurrence, L¹ can be (C₁-C₁₀)alkylene. At each occurrence, L¹ can be (C₁-C₅)alkylene. At each occurrence, L¹ can be a bond.

At each occurrence, PE can be independently selected from —(O—R⁴)ₙ—O—. At each occurrence, R⁴ can be independently selected from the group consisting of —H and a substituted or unsubstituted (C₂-C₂₀)alkylene. At each occurrence, R⁴ can be independently selected from (C₁-C₁₀)alkylene. At each occurrence, R⁴ can be independently selected from (C₁-C₂₀)alkylene. At each occurrence, R⁴ can be ethylene.

At each occurrence R³ can be independently selected from the group consisting of —H and a substituted or unsubstituted (C₂-C₂₀)alkylene. At each occurrence R³ can be independently selected from the group consisting of —H and (C₁-C₁₀)alkyl. At each occurrence R³ can be independently selected from the group consisting of —H, methyl, and ethyl. At each occurrence R³ can be —H.

The variable n can be about 1 to about 10,000, about 1 to about 100, or about 1, 2, 3, 4, 5, 6, 7, 8, 9, 10, 11, 12, 13, 14, 15, 16, 17, 18, 19, 20, 22, 24, 26, 28, 30, 35, 40, 45, 50, 75, 100, 125, 150, 175, 200, 250, 500, 750, 1,000, 1,250, 1,500, 1,750, 2,000, 2,500, 3,000, 4,000, 5,000, 6,000, 7,000, 8,000, 9,000, or about 10,000 or more

The variable x can be about 0 to about 100,000, 1 to about 50,000, 1 to about 10,000, about 1 to about 1,000, or about 1, 2, 3, 4, 5, 6, 8, 10, 12, 14, 16, 18, 20, 25, 30, 35, 40, 45, 50, 75, 100, 125, 150, 175, 200, 250, 500, 750, 1,000, 1,500, 2,000, 2,500, 3,000, 4,000, 5,000, 6,000, 7,000, 8,000, 9,000, 10,000, 15,000, 20,000, 25,000, 50,000, 75,000, or about 100,000 or more.

The variable y can be about 0 to about 100,000, 1 to about 50,000, 1 to about 10,000, about 1 to about 1,000, or about 1, 2, 3, 4, 5, 6, 8, 10, 12, 14, 16, 18, 20, 25, 30, 35, 40, 45, 50, 75, 100, 125, 150, 175, 200, 250, 500, 750, 1,000, 1,500, 2,000, 2,500, 3,000, 4,000, 5,000, 6,000, 7,000, 8,000, 9,000, 10,000, 15,000, 20,000, 25,000, 50,000, 75,000, or about 100,000 or more. In some embodiments, y is 0, and at least one R² can be the group —C—PE-R³.

The polyether-functionalized polysiloxane can have a molecular weight of about 250 g/mol to about 5,000,000 g/mol, or about 500 g/mol to about 5,000,000 g/mol, or about 250 g/mol or less, or about 300 g/mol, 400, 500, 600, 800, 1,000, 1,500, 2,000, 3,000, 4,000, 5,000, 6,000, 8,000, 10,000, 15,000, 20,000, 25,000, 50,000, 100,000, 150,000, 200,000, 250,000, 500,000, 1,000,000, 1,500,000, 2,000,000, 2,500,000, or about 5,000,000 g/mol or more.

In some embodiments, the polyether-functionalized polysiloxane has the structure:

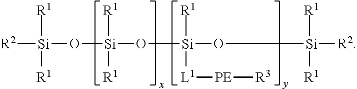

In some embodiments, a trisiloxane structure can give good equilibrium surface tension reduction and excellent wetting between an aqueous solution and plastic surfaces and other low-energy substrates. In some embodiments, a trisiloxane can have large capacity for lowering the liquid/solid interfacial tension.

In some embodiments, the polyether-functionalized polysiloxane has the structure:

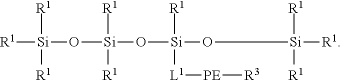

In some embodiments, the polyether-functionalized polysiloxane has the structure:

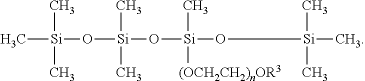

In various embodiments, higher molecular weight polyether-functionalized polysiloxane surfactants, such as those having rake structures, can give moderate wetting to aqueous solutions. However, materials of these types can be used to provide other benefits, for instance mar-resistance, friction reduction, and de-aeration.

In some embodiments, the polyether-functionalized polysiloxane has the structure:

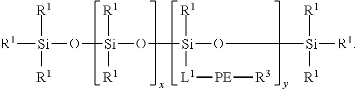

In some embodiments, the polyether-functionalized polysiloxane has the structure:

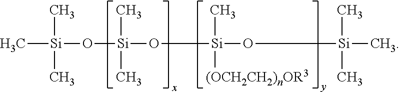

In some embodiments, the polyether-functionalized polysiloxane has the structure:

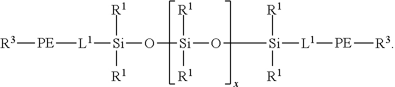

In some embodiments, the polyether-functionalized polysiloxane has the structure:

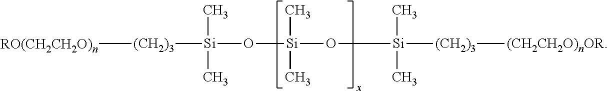

### Other Components.

The composition including the polyether-functionalized polysiloxane, or a mixture including the composition, can include any suitable additional component in any suitable proportion, such that the polyether-functionalized polysiloxane, composition, or mixture including the same can be used as described herein.

In some embodiments, the composition includes a viscosifier. The viscosifier can be any suitable viscosifier. The viscosifier can affect the viscosity of the composition or a solvent that contacts the composition at any suitable time and location. In some embodiments, the viscosifier provides an increased viscosity at least one of before injection to the subterranean formation (e.g., downhole), at the time of injection, during travel through a tubular disposed in a borehole, once the composition reaches a particular subterranean location, or some period of time after the composition reaches a particular subterranean location. In some embodiments, the viscosifier can be about 0.000,1 wt % to about 10 wt % of the composition, about 0.004 wt % to about 0.01 wt % of the composition, or about 0.000,1 wt % or less, 0.000,5 wt %, 0.001, 0.005, 0.01, 0.05, 0.1, 0.5, 1, 2, 3, 4, 5, 6, 7, 8, 9, or about 10 wt % or more of the composition.

The viscosifier can include at least one of a substituted or unsubstituted polysaccharide, and a substituted or unsubstituted polyalkenylene, wherein the polysaccharide or polyalkenylene is crosslinked or uncrosslinked. The viscosifier can include a polymer including at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and poly((C₂-C₁₀)alkenylene), wherein the (C₂-C₁₀)alkenylene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar (e.g., hydroxypropyl guar, carboxy methyl guar, or carboxymethyl hydroxylpropyl guar), gum ghatti, gum arabic, locust bean gum, and derivatized cellulose (e.g., carboxymethyl cellulose, hydroxyethyl cellulose, carboxymethyl hydroxyethyl cellulose, hydroxypropyl cellulose, or methyl hydroxyl ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include a crosslinker. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. The crosslinker can be about 0.000,01 wt % to about 5 wt % of the composition, about 0.001 wt % to about 0.01 wt %, or about 0.000,01 wt % or less, or about 0.000,05 wt %, 0.000,1, 0.000,5, 0.001, 0.005, 0.01, 0.05, 0.1, 0.5, 1, 2, 3, 4, or about 5 wt % or more.

In some embodiments, the composition can include a breaker. The breaker can be any suitable breaker, such that the surrounding fluid (e.g., a fracturing fluid) can be at least partially broken for more complete and more efficient recovery thereof at the conclusion of the hydraulic fracturing treatment. In some embodiments, the breaker can be encapsulated or otherwise formulated to give a delayed-release or a time-release, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, include any suitable fluid. For example, the fluid can be at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon including an internal olefin, a hydrocarbon including an alpha olefin, xylenes, an ionic liquid, methyl ethyl ketone, and cyclohexanone. The fluid can form about 0.001 wt % to about 99.999 wt % of the composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the polyether-functionalized polysiloxane can include any suitable downhole fluid (e.g., any fluid for use in a subterranean formation). The composition including the polyether-functionalized polysiloxane can be combined with any suitable downhole fluid before, during, or after the placement of the composition in the subterranean formation or the contacting of the composition and the subterranean material. In some examples, the composition including the polyether-functionalized polysiloxane is combined with a downhole fluid above the surface, and then the combined composition is placed in a subterranean formation or contacted with a subterranean material. In another example, the composition including the polyether-functionalized polysiloxane is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used downhole, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

In various embodiments, the composition including the polyether-functionalized polysiloxane or a mixture including the same can include any suitable downhole fluid, such as an aqueous or oil-based fluid including a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.000,000,01 wt % to about 99.999,99 wt %, about 0.000,1 wt % to about 99.9 wt %, about 0.1 wt % to about 99.9 wt %, about 20 wt % to about 90 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999,9 wt %, or about 99.999,99 wt % or more of the composition or mixture including the same.

In some embodiments, the composition or a mixture including the same can include any suitable amount of any suitable material used in a downhole fluid. For example, the composition can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, pozzolan lime, or a combination thereof. In various embodiments, the composition can include one or more additive components such as: thinner additives such as COLDTROL®, ATC®, OMC 2™, and OMC 42™; RHEMOD™, a viscosifier and suspension agent including a modified fatty acid; additives for providing temporary increased viscosity, such as for shipping (e.g., transport to the well site) and for use in sweeps (for example, additives having the trade name TEMPERUS™ (a modified fatty acid) and VIS-PLUS®, a thixotropic viscosifying polymer blend); TAU-MOD™, a viscosifying/suspension agent including an amorphous/fibrous material; additives for filtration control, for example, ADAPTA®, a high temperature high pressure (HTHP) filtration control agent including a crosslinked copolymer; DURATONE® HT, a filtration control agent that includes an organophilic lignite, more particularly organophilic leonardite; THERMO TONE™, a HTHP filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a sized ground marble bridging agent; BAROID®, a ground barium sulfate weighting agent; BAROLIFT®, a hole sweeping agent; SWEEP-WATE®, a sweep weighting agent; BDF-508, a diamine dimer rheology modifier; GELTONE® II organophilic clay; BAROFIBRE™ O for lost circulation management and seepage loss prevention, including a natural cellulose fiber; STEELSEAL®, a resilient graphitic carbon lost circulation material; HYDRO-PLUG®, a hydratable swelling lost circulation material; lime, which can provide alkalinity and can activate certain emulsifiers; and calcium chloride, which can provide salinity. Any suitable proportion of the composition or mixture including the composition can include any optional component listed in this paragraph, such as about 0.000,000,01 wt % to about 99.999,99 wt %, about 0.000,1 to about 99.9 wt %, about 0.1 wt % to about 99.9 wt %, about 20 to about 90 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999,9 wt %, or about 99.999,99 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the mixture with the composition including the polyether-functionalized polysiloxane in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, 99.999, or about 99.9999 wt % or more of the mixture.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the polyether-functionalized polysiloxane can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, about 0 wt % to about 95 wt %, about 20 wt % to about 95 wt %, or about 50 wt % to about 90 wt %. A cement kiln dust can be present in an amount of at least about 0.01 wt %, or about 5 wt % to about 80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.000,1 wt % to about 99.9 wt %, about 0.1 wt % to about 80 wt %, about 10 wt % to about 60 wt %, or about 0.000,000,01 wt % or less, or about 0.000,001 wt %, 0.000,1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### Drilling Assembly.

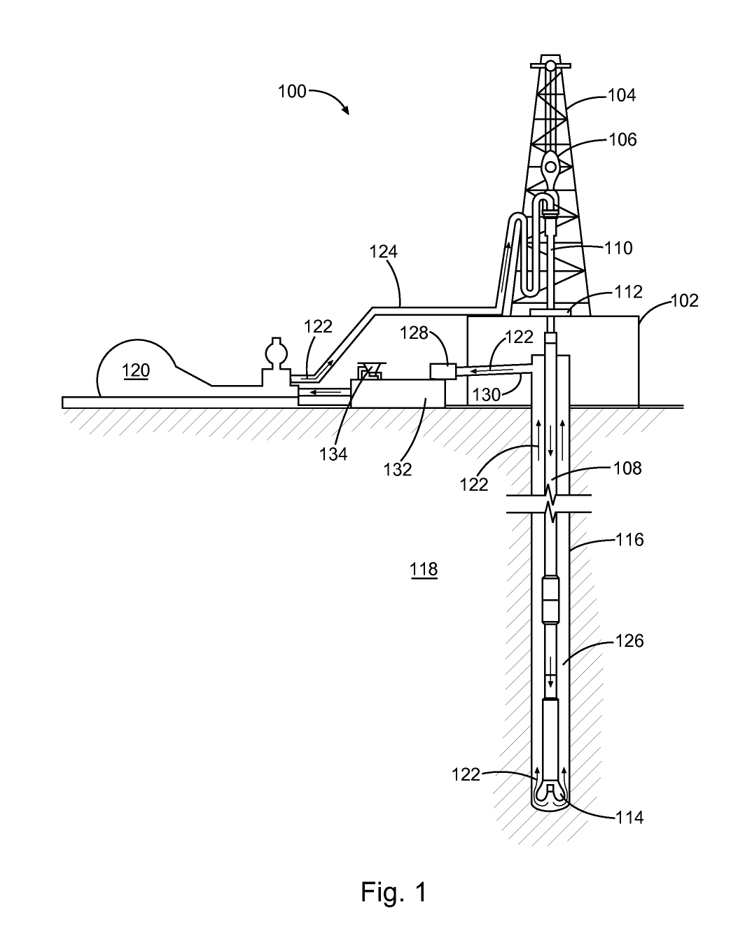

In various embodiments, the composition including the polyether-functionalized polysiloxane disclosed herein (or a mixture including the same) can directly or indirectly affect one or more components or pieces of equipment associated with the preparation, delivery, recapture, recycling, reuse, and/or disposal of the disclosed composition including the polyether-functionalized polysiloxane. For example, and with reference to FIG. 1, the disclosed composition including the polyether-functionalized polysiloxane can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the polyether-functionalized polysiloxane can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the polyether-functionalized polysiloxane can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the polyether-functionalized polysiloxane can be stored, reconditioned, and/or regulated until added to the drilling fluid 122.

As mentioned above, the composition including the polyether-functionalized polysiloxane can directly or indirectly affect the components and equipment of the drilling assembly 100. For example, the composition including the polyether-functionalized polysiloxane can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the polyether-functionalized polysiloxane.

The composition including the polyether-functionalized polysiloxane can directly or indirectly affect the pump 120, which representatively includes any conduits, pipelines, trucks, tubulars, and/or pipes used to fluidically convey the composition including the polyether-functionalized polysiloxane downhole, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The composition including the polyether-functionalized polysiloxane can also directly or indirectly affect the mixing hopper 134 and the retention pit 132 and their assorted variations.

The composition including the polyether-functionalized polysiloxane can also directly or indirectly affect the various downhole equipment and tools that can come into contact with the composition including the polyether-functionalized polysiloxane such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the polyether-functionalized polysiloxane can also directly or indirectly affect any downhole heat exchangers, valves and corresponding actuation devices, tool seals, packers and other wellbore isolation devices or components, and the like associated with the wellbore 116. The composition including the polyether-functionalized polysiloxane can also directly or indirectly affect the drill bit 114, which can include roller cone bits, polycrystalline diamond compact (PDC) bits, natural diamond bits, any hole openers, reamers, coring bits, and the like.

While not specifically illustrated herein, the composition including the polyether-functionalized polysiloxane can also directly or indirectly affect any transport or delivery equipment used to convey the composition including the polyether-functionalized polysiloxane to the drilling assembly 100 such as, for example, any transport vessels, conduits, pipelines, trucks, tubulars, and/or pipes used to fluidically move the composition including the polyether-functionalized polysiloxane from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include a composition including a polyether-functionalized linear polysiloxane. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), the tubular containing a composition including the polyether-functionalized polysiloxane described herein.

In some embodiments, the system can include a drillstring disposed in a wellbore, the drillstring including a drill bit at a downhole end of the drillstring. The system can also include an annulus between the drillstring and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

The pump can be a high pressure pump in some embodiments. As used herein, the term “high pressure pump” will refer to a pump that is capable of delivering a fluid to a subterranean formation at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to a subterranean formation.

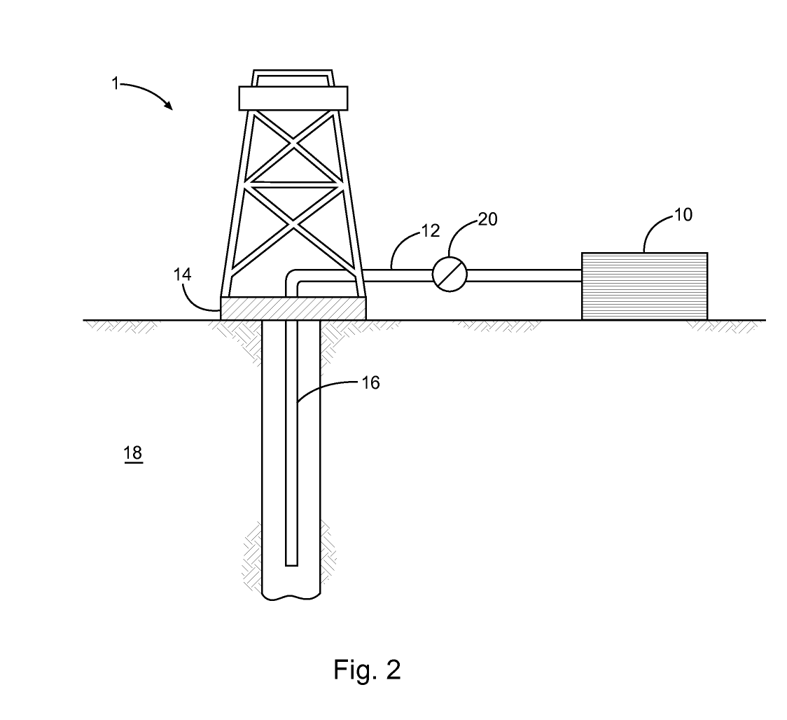

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include a polyether-functionalized linear polysiloxane. In some embodiments, the composition further includes a downhole fluid. The downhole fluid can be any suitable downhole fluid. In some embodiments, the downhole fluid is a composition for fracturing of a subterranean formation or subterranean material, or a fracturing fluid (e.g., pre-pad, pad, slurry, or finishing stages).

### Method for Preparing a Composition for Treatment of a Subterranean Formation.

In various embodiments, the present invention provides a method for preparing a composition for treatment of a subterranean formation. The method can be any suitable method that produces an embodiment of a composition described herein. For example, the method can include forming a composition including a polyether-functionalized linear polysiloxane. The composition can also include a downhole fluid, such as a fracturing fluid or a drilling fluid.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### ADDITIONAL EMBODIMENTS

The following exemplary embodiments are provided, the numbering of which is not to be construed as designating levels of importance:

Embodiment 1 provides a method of treating a subterranean formation, the method comprising:

obtaining or providing a composition comprising

a polyether-functionalized linear polysiloxane; and

placing the composition in a subterranean formation.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs in the subterranean formation.

Embodiment 4 provides the method of any one of Embodiments 1-3, wherein the polyether-functionalized polysiloxane is at least one of a surface modifier, an interface modifier, a defoamer, an antifoamer, a de-aerator, a demulsifier, a friction reducer, a flow enhancer, a surface protector, a solubilizer, a softener, and a corrosion inhibitor.

Embodiment 5 provides the method of any one of Embodiments 1-4, wherein the method is a method of fracturing the subterranean formation.

Embodiment 6 provides the method of any one of Embodiments 1-5, wherein the method is a method of drilling the subterranean formation.

Embodiment 7 provides the method of any one of Embodiments 1-6, wherein the composition includes an aqueous liquid.

Embodiment 8 provides the method of Embodiment 7, wherein about 0.01 wt % to about 99 wt % of the composition is water.

Embodiment 9 provides the method of any one of Embodiments 7-8, wherein the method further comprises mixing the aqueous liquid with the polyether-functionalized polysiloxane.

Embodiment 10 provides the method of Embodiment 9, wherein the mixing occurs above surface.

Embodiment 11 provides the method of any one of Embodiments 9-10, wherein the mixing occurs in the subterranean formation.

Embodiment 12 provides the method of any one of Embodiments 7-11, wherein the aqueous liquid comprises at least one of water, brine, produced water, flowback water, brackish water, and sea water.

Embodiment 13 provides the method of any one of Embodiments 7-12, wherein the aqueous liquid comprises salt water having a total dissolved solids level of about 1,000 mg/L to about 250,000 mg/L.

Embodiment 14 provides the method of any one of Embodiments 7-13, wherein the aqueous liquid comprises at least one of a drilling fluid, a pre-pad fluid, a pad fluid, a fracturing fluid, and a post-fracturing fluid.

Embodiment 15 provides the method of any one of Embodiments 1-14, wherein about 0.000,1 wt % to about 100 wt % of the composition is the polyether-functionalized polysiloxane.

Embodiment 16 provides the method of any one of Embodiments 1-15, wherein about 0.01 wt % to about 5 wt % of the composition is the polyether-functionalized linear polysiloxane.

Embodiment 17 provides the method of any one of Embodiments 7-16, wherein about 0.000,1 wt % to about 10 wt % of the composition is the polyether-functionalized linear polysiloxane.

Embodiment 18 provides the method of any one of Embodiments 1-17, wherein the polyether-functionalized polysiloxane has the structure:

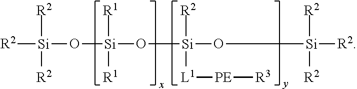

wherein,

at each occurrence R¹ is independently selected from a substituted or unsubstituted (C₁-C₂₀)hydrocarbyl,

at each occurrence R² is independently selected from the group consisting of —R′ and -L¹-PE-R³,

at each occurrence L¹ is independently selected from the group consisting of a bond and a substituted or unsubstituted (C₁-C₂₀)alkylene,

at each occurrence PE is independently selected from —(O—R⁴)ₙ—O—,

at each occurrence R³ is independently selected from the group consisting of —H and a substituted or unsubstituted (C₂-C₂₀)alkylene,

at each occurrence R⁴ is independently substituted or unsubstituted (C₂-C₂₀)alkylene,

n is about 1 to about 10,000, x is about 0 to about 100,000, y is about 0 to about 100,000, and x+y is at least 1, and

the polyether-functionalized polysiloxane comprises at least one polyether.

Embodiment 19 provides the method of Embodiment 18, wherein at each occurrence R¹ is independently selected from (C₁-C₂₀)alkyl.

Embodiment 20 provides the method of any one of Embodiments 18-19, wherein at each occurrence R¹ is independently selected from (C₁-C₅)alkyl.

Embodiment 21 provides the method of any one of Embodiments 18-20, wherein at each occurrence R¹ is methyl.

Embodiment 22 provides the method of any one of Embodiments 18-21, wherein at each occurrence L¹ is (C₁-C₁₀)alkylene.

Embodiment 23 provides the method of any one of Embodiments 18-22, wherein at each occurrence L¹ is (C₁-C₅)alkylene.

Embodiment 24 provides the method of any one of Embodiments 18-23, wherein at each occurrence L¹ is a bond.

Embodiment 25 provides the method of any one of Embodiments 18-24, wherein at each occurrence R⁴ is independently selected from (C₁-C₂₀)alkylene.

Embodiment 26 provides the method of any one of Embodiments 18-25, wherein at each occurrence R⁴ is independently selected from (C₁-C₁₀)alkylene.

Embodiment 27 provides the method of any one of Embodiments 18-26, wherein at each occurrence R⁴ is ethylene.

Embodiment 28 provides the method of any one of Embodiments 18-27, wherein at each occurrence R³ is independently selected from the group consisting of —H and (C₁-C₁₀)alkyl.

Embodiment 29 provides the method of any one of Embodiments 18-28, wherein at each occurrence R³ is independently selected from the group consisting of —H, methyl, and ethyl.

Embodiment 30 provides the method of any one of Embodiments 18-29, wherein at each occurrence R³ is —H.

Embodiment 31 provides the method of any one of Embodiments 18-30, wherein at each occurrence, n is about 1 to about 100.

Embodiment 32 provides the method of any one of Embodiments 18-31, wherein x is about 1 to about 1,000.

Embodiment 33 provides the method of any one of Embodiments 18-32, wherein y is about 1 to about 1,000.

Embodiment 34 provides the method of any one of Embodiments 18-33, wherein y is 0.

Embodiment 35 provides the method of any one of Embodiments 18-34, wherein the polyether-functionalized polysiloxane has a molecular weight of about 250 g/mol to about 5,000,000 g/mol.

Embodiment 36 provides the method of any one of Embodiments 18-35, wherein the polyether-functionalized polysiloxane has the structure:

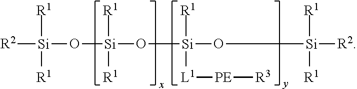

Embodiment 37 provides the method of any one of Embodiments 18-36, wherein the polyether-functionalized polysiloxane has the structure:

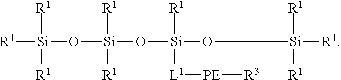

Embodiment 38 provides the method of any one of Embodiments 18-37, wherein the polyether-functionalized polysiloxane has the structure:

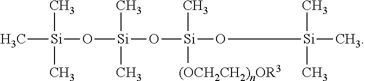

Embodiment 39 provides the method of any one of Embodiments 18-38, wherein the polyether-functionalized polysiloxane has the structure:

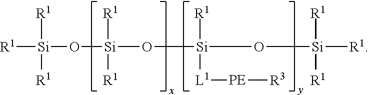

Embodiment 40 provides the method of any one of Embodiments 18-39, wherein the polyether-functionalized polysiloxane has the structure:

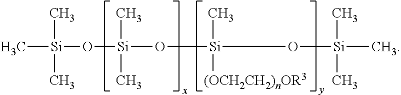

Embodiment 41 provides the method of any one of Embodiments 18-40, wherein the polyether-functionalized polysiloxane has the structure:

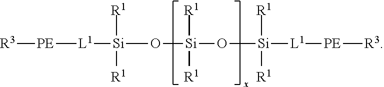

Embodiment 42 provides the method of any one of Embodiments 18-41, wherein the polyether-functionalized polysiloxane has the structure:

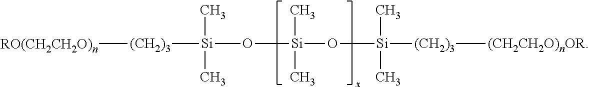

Embodiment 43 provides the method of any one of Embodiments 1-42, wherein the composition further comprises a viscosifier.

Embodiment 44 provides the method of Embodiment 43, wherein the viscosifier is about 0.000,1 wt % to about 10 wt % of the composition.

Embodiment 45 provides the method of any one of Embodiments 43-44, wherein the viscosifier is about 0.004 wt % to about 0.01 wt % of the composition.

Embodiment 46 provides the method of any one of Embodiments 43-45, wherein the viscosifier comprises at least one of a substituted or unsubstituted polysaccharide, and a substituted or unsubstituted polyalkenylene, wherein the polysaccharide or polyalkenylene is crosslinked or uncrosslinked.

Embodiment 47 provides the method of any one of Embodiments 43-46, wherein the viscosifier comprises a polymer comprising at least one monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide.

Embodiment 48 provides the method of any one of Embodiments 43-47, wherein the viscosifier comprises a crosslinked gel or a crosslinkable gel.

Embodiment 49 provides the method of any one of Embodiments 43-48, wherein the viscosifier comprises at least one of a linear polysaccharide, and poly((C₂-C₁₀)alkenylene), wherein the (C₂-C₁₀)alkenylene is substituted or unsubstituted.

Embodiment 50 provides the method of any one of Embodiments 43-49, wherein the viscosifier comprises at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar, gum ghatti, gum arabic, locust bean gum, derivatized cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Embodiment 51 provides the method of any one of Embodiments 43-50, wherein the viscosifier comprises at least one of a poly(vinyl alcohol) homopolymer, poly(vinyl alcohol) copolymer, a crosslinked poly(vinyl alcohol) homopolymer, and a crosslinked poly(vinyl alcohol) copolymer.

Embodiment 52 provides the method of any one of Embodiments 1-51, wherein the composition further comprises a crosslinker.

Embodiment 53 provides the method of any one of Embodiments 52, wherein the crosslinker is about 0.000,01 wt % to about 5 wt % of the composition.

Embodiment 54 provides the method of any one of Embodiments 52-53, wherein the crosslinker is about 0.001 wt % to about 0.01 wt % of the composition.

Embodiment 55 provides the method of any one of Embodiments 52-54, wherein the crosslinker comprises at least one of chromium, aluminum, antimony, zirconium, titanium, calcium, boron, iron, silicon, copper, zinc, magnesium, and an ion thereof.

Embodiment 56 provides the method of any one of Embodiments 52-55, wherein the crosslinker comprises at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate.

Embodiment 57 provides the method of any one of Embodiments 1-56, wherein the composition further comprises a breaker.

Embodiment 58 provides the method of Embodiment 57, wherein the breaker is about 0.001 wt % to about 30 wt % of the composition.

Embodiment 59 provides the method of any one of Embodiments 57-58, wherein the breaker is about 0.01 wt % to about 5 wt % of the composition.

Embodiment 60 provides the method of any one of Embodiments 57-59, wherein the breaker comprises at least one of an oxidative breaker and an enzymatic breaker.

Embodiment 61 provides the method of Embodiment 60, wherein the oxidative breaker is at least one of a Na⁺, K⁺, Li⁺, Zn⁺, NH₄⁺, Fe²⁺, Fe³⁺, Cu¹⁺, Cu²⁺, Ca²⁺, Me²⁺, Zn²⁺, and an Al³⁺ salt of a persulfate, percarbonate, perborate, peroxide, perphosphosphate, permanganate, chlorite, or hyperchlorite ion.

Embodiment 62 provides the method of any one of Embodiments 60-61, wherein the enzymatic breaker is at least one of an alpha or beta amylase, amyloglucosidase, oligoglucosidase, invertase, maltase, cellulase, hemi-cellulase, and mannanohydrolase.

Embodiment 63 provides the method of any one of Embodiments 1-62, wherein the composition further comprises a fluid comprising at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon comprising an internal olefin, a hydrocarbon comprising an alpha olefin, xylenes, an ionic liquid, methyl ethyl ketone, and cyclohexanone.

Embodiment 64 provides the method of any one of Embodiments 1-63, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof, to form a mixture, wherein the placing the composition in the subterranean formation comprises placing the mixture in the subterranean formation.

Embodiment 65 provides the method of any one of Embodiments 1-64, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

Embodiment 66 provides the method of any one of Embodiments 1-65, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 67 provides the method of any one of Embodiments 1-66, wherein the composition further comprises a proppant, a resin-coated proppant, or a combination thereof.

Embodiment 68 provides the method of any one of Embodiments 1-67, wherein the placing of the composition in the subterranean formation comprises pumping the composition through a drill string disposed in a wellbore, through a drill bit at a downhole end of the drill string, and back above-surface through an annulus.

Embodiment 69 provides the method of Embodiment 68, further comprising processing the composition exiting the annulus with at least one fluid processing unit to generate a cleaned composition and recirculating the cleaned composition through the wellbore.

Embodiment 70 provides a system for performing the method of any one of Embodiments 1-69, the system comprising:

a tubular disposed in a wellbore; and

a pump configured to pump the composition into the subterranean formation through the tubular.

Embodiment 71 provides a system for performing the method of any one of Embodiments 1-70, the system comprising:

a drillstring disposed in a wellbore, the drillstring comprising a drill bit at a downhole end of the drillstring;

an annulus between the drillstring and the wellbore; and

a pump configured to circulate the composition through the drill string, through the drill bit, and back above-surface through the annulus.

Embodiment 72 provides a method of treating a subterranean formation, the method comprising:

obtaining or providing a composition comprising

a polyether-functionalized linear polysiloxane having the structure

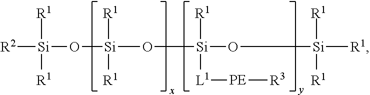

wherein,
at each occurrence R¹ is independently selected from a (C₁-C₅)alkyl,
at each occurrence R² is independently selected from the group consisting of —R¹ and -L¹-PE-R³,
at each occurrence L¹ is independently selected from the group consisting of a bond and a (C₁-C₅)alkylene,
at each occurrence PE is independently selected from —(O—R⁴)ₙ—O—,
at each occurrence R³ is independently selected from the group consisting of —H, methyl, and ethyl,
at each occurrence R⁴ is independently substituted or unsubstituted (C₂-C₅)alkylene,
n is about 1 to about 10,000, x is about 0 to about 100,000, y is about 0 to about 100,000, and x+y is at least 1, and
the polyether-functionalized polysiloxane comprises at least one polyether; and

at least one of a fracturing fluid or a drilling fluid, wherein about 0.000,1 wt % to about 10 wt % of the composition is the polyether-functionalized polysiloxane; and

placing the composition in a subterranean formation.

Embodiment 73 provides a system comprising:

a composition comprising a polyether-functionalized linear polysiloxane; and

a subterranean formation comprising the composition therein.

Embodiment 74 provides the system of Embodiment 73, further comprising

a drillstring disposed in a wellbore, the drillstring comprising a drill bit at a downhole end of the drillstring;

an annulus between the drillstring and the wellbore; and

a pump configured to circulate the composition through the drill string, through the drill bit, and back above-surface through the annulus.

Embodiment 75 provides the system of Embodiment 74, further comprising a fluid processing unit configured to process the composition exiting the annulus to generate a cleaned drilling fluid for recirculation through the wellbore.

Embodiment 76 provides the system of any one of Embodiments 73-75, further comprising

a tubular disposed in a wellbore; and

a pump configured to pump the composition into the subterranean formation through the tubular.

Embodiment 77 provides a composition for treatment of a subterranean formation, the composition comprising:

a polyether-functionalized linear polysiloxane; and

a downhole fluid.

Embodiment 78 provides the composition of Embodiment 77, wherein the composition further comprises a downhole fluid.

Embodiment 79 provides the composition of any one of Embodiments 77-78, wherein the composition is a composition for fracturing of a subterranean formation.

Embodiment 80 provides a composition for treatment of a subterranean formation, the composition comprising:

a polyether-functionalized linear polysiloxane having the structure

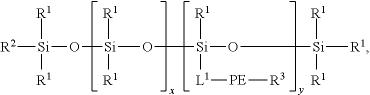

wherein,

at each occurrence R¹ is independently selected from a (C₁-C₅)alkyl,

at each occurrence R² is independently selected from the group consisting of —R¹ and -L¹-PE-R³,

at each occurrence L¹ is independently selected from the group consisting of a bond and a (C₁-C₅)alkylene,

at each occurrence PE is independently selected from —(O—R⁴)ₙ—O—,

at each occurrence R⁴ is independently a substituted or unsubstituted (C₂-C₅)alkylene,

at each occurrence R³ is independently selected from the group consisting of —H, methyl, and ethyl,

n is about 1 to about 10,000, x is about 0 to about 100,000, y is about 0 to about 100,000, and x+y is at least 1, and

the polyether-functionalized polysiloxane comprises at least one polyether; and

at least one of a fracturing fluid or a drilling fluid, wherein about 0.000,1 wt % to about 10 wt % of the composition is the polyether-functionalized polysiloxane.

Embodiment 81 provides a method of preparing a composition for treatment of a subterranean formation, the method comprising:

forming a composition comprising

a composition comprising a polyether-functionalized linear polysiloxane; and

a downhole fluid.

Embodiment 82 provides the composition, apparatus, method, or system of any one or any combination of Embodiments 1-81 optionally configured such that all elements or options recited are available to use or select from.

1-81. (canceled)

82. A method of treating a subterranean formation, the method comprising:
obtaining or providing a composition comprising a polyether-functionalized linear polysiloxane; and
placing the composition in a subterranean formation.

83. The method of claim 82, wherein the polyether-functionalized polysiloxane is at least one of a surface modifier, an interface modifier, a defoamer, an antifoamer, a de-aerator, a demulsifier, a friction reducer, a flow enhancer, a surface protector, a solubilizer, a softener, and a corrosion inhibitor.

84. The method of claim 82, wherein about 0.01 wt % to about 99 wt % of the composition is water.

85. The method of claim 82, wherein the method further comprises mixing water with the polyether-functionalized polysiloxane.

86. The method of claim 82, wherein about 0.000,1 wt % to about 100 wt % of the composition is the polyether-functionalized polysiloxane.

87. The method of claim 82, wherein the polyether-functionalized polysiloxane has the structure: 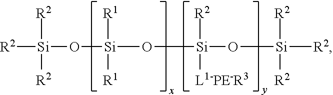
wherein,
at each occurrence R¹ is independently selected from a substituted or unsubstituted (C₁-C₂₀)hydrocarbyl,
at each occurrence R² is independently selected from the group consisting of —R¹ and -L¹-PE-R³,
at each occurrence L¹ is independently selected from the group consisting of a bond and a substituted or unsubstituted (C₁-C₂₀)alkylene,
at each occurrence PE is independently selected from —(O—R⁴)ₙ—O—,
at each occurrence R³ is independently selected from the group consisting of —H and a substituted or unsubstituted (C₂-C₂₀)alkylene,
at each occurrence R⁴ is independently substituted or unsubstituted (C₂-C₂₀)alkylene,
n is about 1 to about 10,000, x is about 0 to about 100,000, y is about 0 to about 100,000, and x+y is at least 1, and
the polyether-functionalized polysiloxane comprises at least one polyether.

88. The method of claim 87, wherein at each occurrence R⁴ is ethylene.

89. The method of claim 87, wherein at each occurrence R³ is independently selected from the group consisting of —H, methyl, and ethyl.

90. The method of claim 87, wherein the polyether-functionalized polysiloxane has the structure:

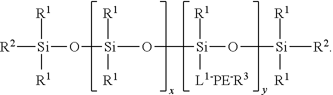

91. The method of claim 87, wherein the polyether-functionalized polysiloxane has the structure:

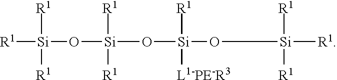

92. The method of claim 87, wherein the polyether-functionalized polysiloxane has the structure:

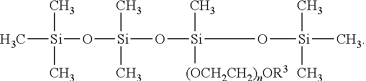

93. The method of claim 87, wherein the polyether-functionalized polysiloxane has the structure:

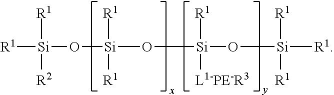

94. The method of claim 87, wherein the polyether-functionalized polysiloxane has the structure:

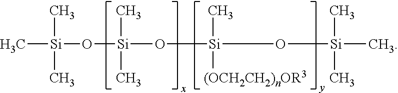

95. The method of claim 87, wherein the polyether-functionalized polysiloxane has the structure:

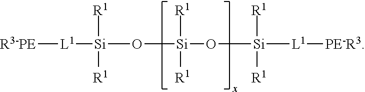

96. The method of claim 87, wherein the polyether-functionalized polysiloxane has the structure:

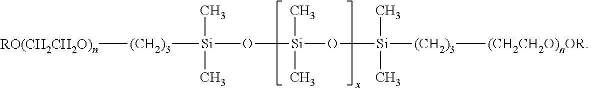

97. The method of claim 82, wherein the composition further comprises a viscosifier.

98. The method of claim 82, wherein the composition further comprises a crosslinker.

99. The method of claim 82, wherein the composition further comprises a breaker.

100. A method of treating a subterranean formation, the method comprising:
obtaining or providing a composition comprising
a polyether-functionalized linear polysiloxane having the structure 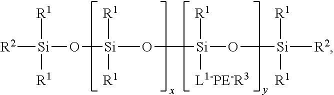
wherein,
at each occurrence R¹ is independently selected from a (C₁-C₅)alkyl,
at each occurrence R² is independently selected from the group consisting of —R¹ and -L¹-PE-R³,
at each occurrence L¹ is independently selected from the group consisting of a bond and a (C₁-C₅)alkylene,
at each occurrence PE is independently selected from —(O—R⁴)ₙ—O—,
at each occurrence R³ is independently selected from the group consisting of —H, methyl, and ethyl,
at each occurrence R⁴ is independently substituted or unsubstituted (C₂-C₅)alkylene,
n is about 1 to about 10,000, x is about 0 to about 100,000, y is about 0 to about 100,000, and x+y is at least 1, and
the polyether-functionalized polysiloxane comprises at least one polyether; and
at least one of a fracturing fluid or a drilling fluid, wherein about 0.000,1 wt % to about 10 wt % of the composition is the polyether-functionalized polysiloxane; and
placing the composition in a subterranean formation.

101. A system comprising:
a composition comprising a polyether-functionalized linear polysiloxane; and
a subterranean formation comprising the composition therein.
